(19) United States
(12) Patent Application Publication
(10) Pub. No.: US 2017/0312677 A1
(43) Pub. Date: Nov. 2, 2017

(54) CIRCULAR AIR FILTER AND AIR CLEANER ASSEMBLY FOR VEHICLE HAVING THE AIR FILTER

(71) Applicants: Hyundai Motor Company, Seoul (KR); Kia Motors Corporation, Seoul (KR)

(72) Inventor: Won-Seop Choi, Anyang (KR)

(21) Appl. No.: 15/358,284

(22) Filed: Nov. 22, 2016

(30) Foreign Application Priority Data
Apr. 28, 2016 (KR) 10-2016-0052156

(51) Int. Cl. B01D 46/02; F02M 35/024; B01D 46/00

(52) U.S. Cl. CPC B01D 46/02; F02M 35/02483; F02M 35/02441; B01D 46/0005; F02M 35/02416; B01D 2279/60

(57) ABSTRACT

A circular air filter for vehicle is provided. The circular air filter is mounted in an air cleaner body disposed between an air inlet configured to suction air from an exterior and an air duct configured to provide filtered air to an engine. A frame is formed in a cylinder shape and has a penetration aperture to provide air flow along a circumference thereof. An engaging portion is formed at a first end of the frame and coupled to a first side of the air cleaner body. A non-woven fabric is disposed on an exterior of the frame and is coupled to the engaging portion for filtering foreign materials.

### CROSS-REFERENCE TO RELATED APPLICATION

This application claims priority to the benefit of Korean Patent Application No. 10-2016-0052156 filed in the Korean Intellectual Property Office on Apr. 28, 2016, which is incorporated herein by reference in its entirety.

### BACKGROUND

Field of the Invention

The present invention relates to an air filter configured to filter the air that flows into an engine of a vehicle, and more particularly, to a circular air filter and an air cleaner assembly for a vehicle having improved ease of replacement in a narrow space and improved sealing performance.

Description of the Related Art

Typically, air that flows into a vehicle engine passes through an air cleaner in which an air filter is installed to remove the foreign material contained therein and then the air flows into the engine. For example, as shown in FIG. 1, the air that flows into through an air inlet 1 passes through an air filter 110 mounted in an air cleaner body 2 and the foreign material contained therein is removed. The filtered air (e.g., the air of which foreign material is removed) then flows into an engine. The air filter 110 as shown in FIGS. 2A and 2B includes a structure with a nonwoven fabric 112 that is installed in a rectangular filter frame 111 and a sealing member 113 formed from rubber material seals the circumference of the filter frame 111.

In particular, the air filter 110 for a vehicle according to the related art having the structure as described above includes problems related to difficult replacement and a compromised seal of the sealing member 113 when the air filter 110 is mounted to an air cleaner body 2. For example, to replace the air filter 110, as shown in FIG. 1, an air cleaner cover 3 is separated from the air cleaner body 2 by releasing a plurality of clamps 2a and then the air filter 110 is replaced, by fixing an air cleaner cover 3 using the clamps 2a to complete the replacing work of the air filter 110. However, small vehicles include limited space in an engine room space and therefore the air inlet 1 and the air cleaner body 2, are typically positioned above the engine and substantial space for mounting the rectangular air filter 110 is required thereby creating a difficult layout configuration. Furthermore, the portion that protrudes from the sealing member 113 is disposed between the air cleaner body 2 and the air cleaner cover 3 to provide a seal. However, precise placement of the sealing member 113 between the air cleaner body 2 and the air cleaner cover 3 for the rectangular air filter 110 is difficult to achieve.

The above information disclosed in this section is merely for enhancement of understanding of the background of the invention and therefore it may contain information that does not form the prior art that is already known in this country to a person of ordinary skill in the art.

### SUMMARY

The present invention provides a circular air filter and an air cleaner assembly for a vehicle. In particular, the air filter is advantageously disposed in a narrow space for filtering foreign material by being formed in a cylinder shape and being more easily mounted by insertion into an air cleaner body. The present invention provides a circular air double sealing by engaging a filter engaging portion of the air cleaner body and an engaging portion thereof when coupled to the air cleaner body.

The circular air filter for vehicle according to the present invention may include an air filter mounted in an air cleaner body disposed between an air inlet and configured to suction air from an exterior and an air duct configured to transfer filtered air to an engine. The air filter may include a frame formed in a cylinder shape that forms a penetration aperture through which air passes along a circumference thereof. An engaging portion may be formed at one end (e.g., a first end) of the frame and may be coupled to one side (e.g., a first side) of the air cleaner body. A non-woven fabric may be disposed external to the frame and may be coupled to the engaging portion to filter foreign material.

The engaging portion may be formed from a rubber material. The engaging portion may be formed in a ring shape or the like, and the engaging portion may be inserted to a filter holding portion formed to abut an interior surface and an exterior surface of the engaging portion at a second side of the air cleaner body to support an end portion of the engaging portion.

A fixing portion having a cone shape may be formed at an opposite end portion (e.g., a second end portion) of the engaging portion in the frame. The fixing portion may maintain a fixed position through contact with an end portion of a filter fixing aperture slidably inserted into the air cleaner body to maintain the position of the fixing portion. The fixing portion may be formed of a rubber material. Fixing grooves may be formed at a predetermined depth from a circumference in a circumference direction of the air filter at a surface of the fixing portion. The fixing portion may be inserted (e.g., slid) toward the air filter in the air cleaner body to insert a front end of the fixing portion into the fixing groove to fix the position of the air filter.

In some exemplary embodiments, the air cleaner assembly for a vehicle including the circular air filter according to the present invention may include the air filter, an air cleaner body coupled to the air filter and an air inlet configured to suction air from an exterior and connected with an air duct configured to discharge filtered air to an engine and an air cleaner cover configured to open or close an upper surface of the air cleaner body. A filter holding portion may be doubly extended toward an engaging portion and may be formed to fix the position of the engaging portion of the air filter at the air cleaner body.

A fixing portion having a cone shape may be formed at an opposite second end portion of the engage in the frame of the air filter. A filter fixing aperture may be configured to be inserted (e.g., slidably installed) into the air cleaner body and may abut the fixing portion to fix the position of the fixing portion by moving (e.g., sliding) toward the fixing portion. The circular air filter and the air cleaner assembly for a vehicle having the air filter according to the present invention, provides a composition of an engine compartment layout that may reduce a space for mounting a circular air filter. Additionally, sealing performance may be improved.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary perspective view illustrating a state that an air filter according to a related art is mounted between an air cleaner body and an air cleaner cover;

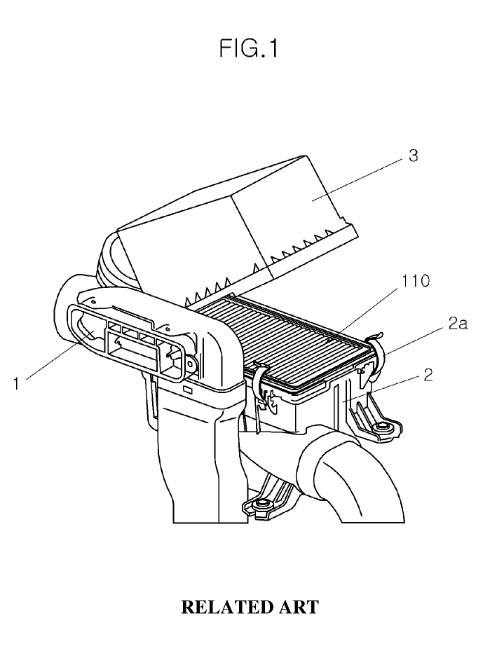

FIG. 2A is an exemplary perspective view illustrating an air filter according to a related art;

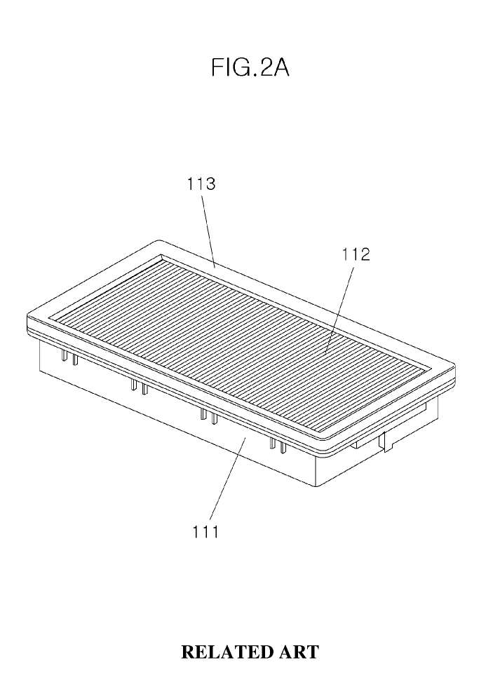

FIG. 2B is an exemplary exploded perspective view illustrating an air filter according to a related art;

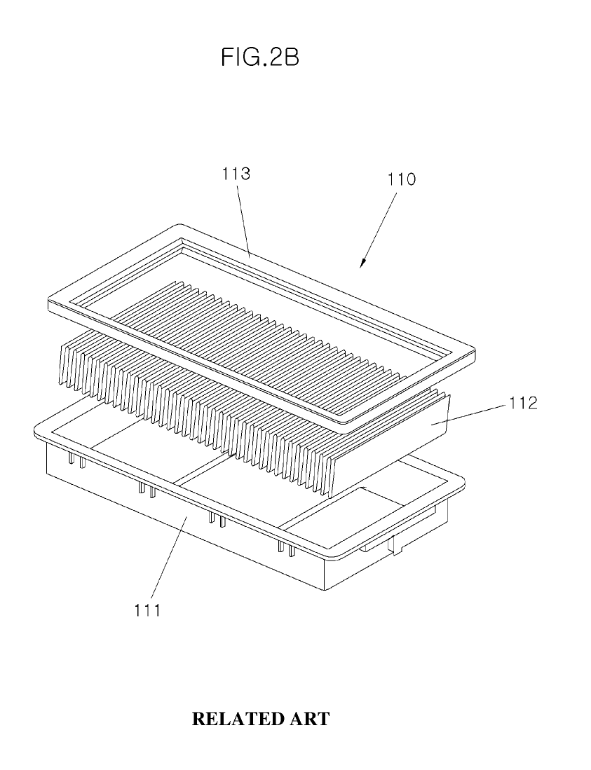

FIG. 3 is an exemplary cross-sectional view illustrating a sealing structure of an air filter according to a related art;

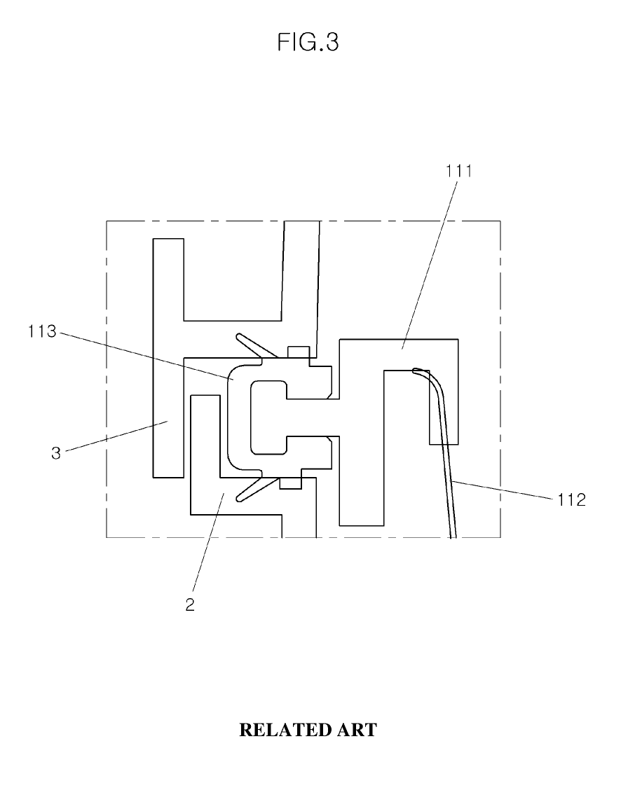

FIG. 4 is an exemplary perspective view illustrating a circular air filter for a vehicle according to an exemplary embodiment of the present invention;

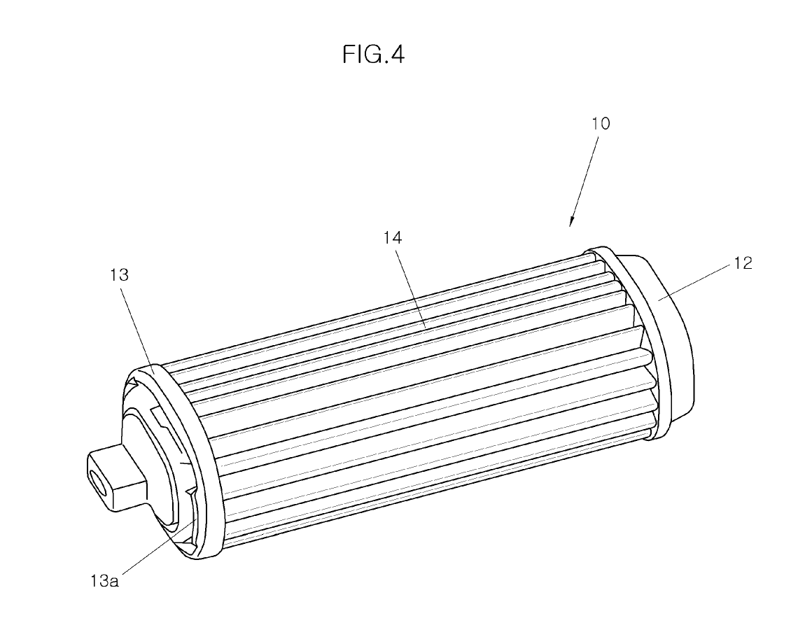

FIG. 5 is an exemplary perspective view illustrating a state that a circular air filter for a vehicle according to an exemplary embodiment of the present invention is mounted in an air cleaner body;

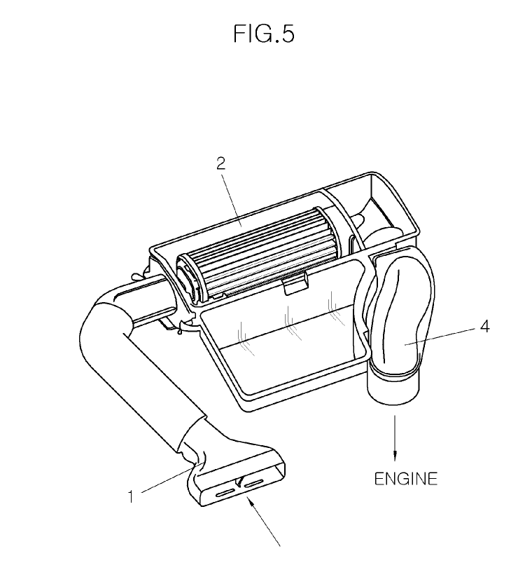

FIG. 6 is an exemplary cross-sectional view illustrating a state of mounting a circular air filter for a vehicle according to the present invention in an air cleaner body;

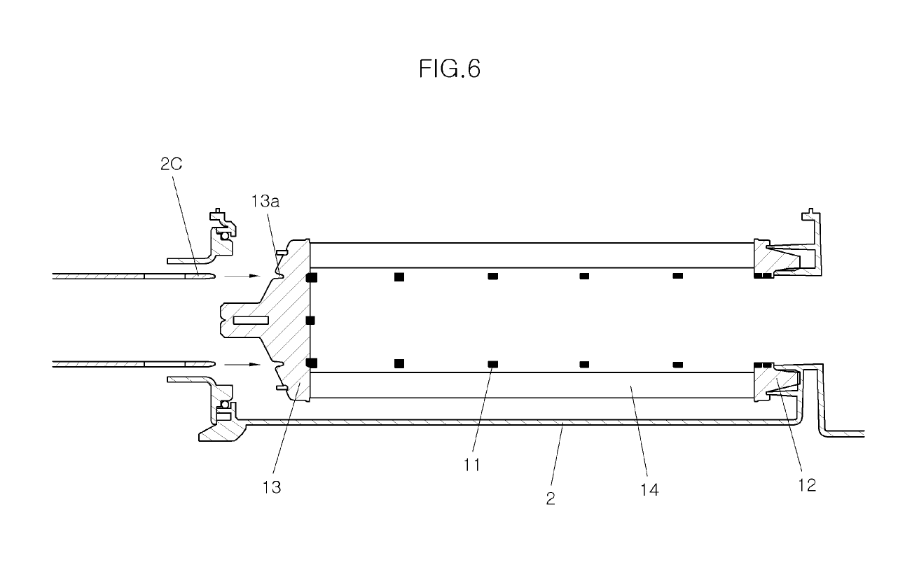

FIG. 7 is an exemplary cross-sectional view illustrating a state of completion of mounting a circular air filter for a vehicle according to an exemplary embodiment of the present invention in an air cleaner body;

FIG. 8 is an exemplary enlarged cross-sectional view illustrating an engaging portion of a circular air filter for a vehicle according to an exemplary embodiment of the present invention;

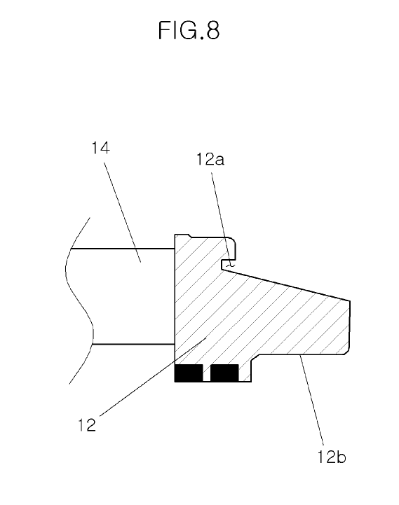

FIG. 9 is an exemplary cross-sectional view illustrating a component that a circular air filter for a vehicle according to an exemplary embodiment of the present invention is engaged with an air cleaner body; and

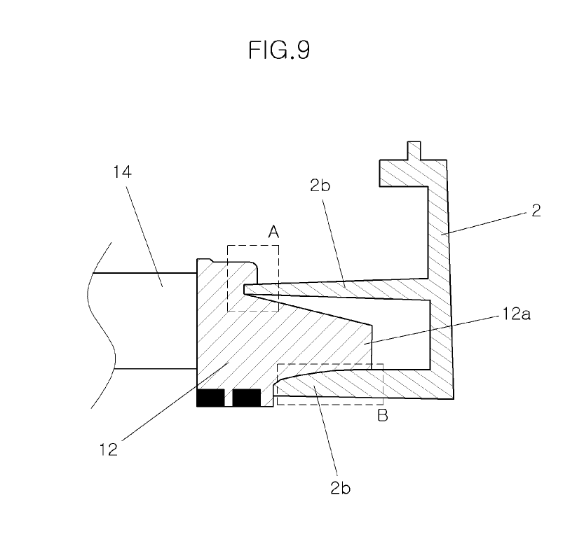

FIG. 10 is an exemplary perspective view illustrating a state of fixing a circular air filter for a vehicle according to an exemplary embodiment of the present invention to an interior of an air cleaner body.

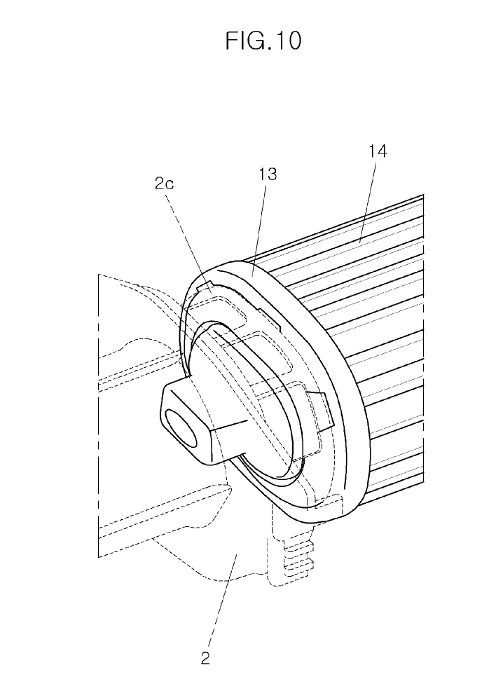

### DETAILED DESCRIPTION

Hereinafter reference will be made in detail to various exemplary embodiments of the present invention, examples of which are illustrated in the accompanying drawings and described below. While the invention will be described in conjunction with exemplary embodiments, it will be understood that the present description is not intended to limit the invention to the exemplary embodiments. On the contrary, the invention is intended to cover not only the exemplary embodiments, but also various alternatives, modifications, equivalents and other exemplary embodiments within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the tem) “vehicle” or “vehicular” or other similar tem) as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, a circular air filter and an air cleaner assembly for a vehicle having the air filter according to the present invention will be described in detail with reference to the accompanying drawings.

A circular air filter for a vehicle according to present invention may include a frame 11 formed in a cylinder shape and may form a penetration aperture configured to enable air flow along a circumference, an engaging portion 12 formed at an end of the frame 11 and coupled to a side of an air cleaner body 2 (e.g., an air cleaner body or an air filter body includes a body or a frame structure), a fixing portion 13 formed in a cone shape at an opposite end of the engaging portion 12 in the frame 11 and a non-woven fabric 14 disposed external to the frame 11 and coupled to the engaging portion 12 configured to filter foreign material. The frame 11 may be formed in a cylinder shape. The frame 11 may be configured to enable air to freely pass through the frame 11 and maintains a shape of the air filter 10. The frame 11 may form a plurality of penetration apertures at a side surface thereof by using a hardened material such as a metal or a synthetic resin. In particular, air may more smoothly flow through the frame 11 as the frame 11 may have a cage shape or the like with a side surface that may be formed as a mesh structure.

The engaging portion 12 may be a portion to fix position of the air filter 10 in the air cleaner body 2. The engaging portion 12 may be formed in a structure of a ring or a cylindrical having a short length, and disposed at an end of the frame 11. The engaging portion 12 may be disposed an end portion of the frame 11 and may be integrally formed with the frame 11. The engaging portion 12 may be formed of a rubber material and may provide a seal by abutting a side of the air cleaner body 2 when the air filter 10 is disposed in the air cleaner body 2 by using the engaging portion 12. An insert groove 12a may be formed to be inserted to a side of the air cleaner body 2 at a position being formed apart from a circumference of the engaging portion 12 toward an interior direction on the engaging portion 12. The insert groove 12a may be formed in a circumference direction of the engaging portion 12 and may provide a primary seal when disposed within the air cleaner body 2.

An interior surface of the engaging portion 12 may be a contact surface 12b which abuts the air cleaner body 2. The contact surface 12b may abut the air cleaner body 2 to doubly perform a sealing together with the insert groove 12a Further, the insert grooves 12a may be formed at an exterior surface of the engaging portion 12 along circumference thereof having a side of the air cleaner body 2 inserted thereto. The fixing portion 13 may be formed at an opposite side of the engaging portion 12 in the frame 11. The fixing portion 13 may be formed in a cone shape. Further, the fixing portion 13 may be coupled together by a filter fixing aperture 2c formed at the air cleaner body 2. A fixing groove 13a may be formed at the fixing portion 13 and the filter fixing aperture 2c may be inserted thereto. The fixing groove 13a may be formed at a surface of the fixing portion 13 in a circumference direction of the fixing portion 13. The fixing portion 13 may be formed of a rubber material too.

The non-woven fabric 14 may be disposed external to the frame 11. The non-woven fabric 14 may be disposed between the engaging portion 12 and the fixing portion 13 on the exterior of the frame 11. As air flows through the non-woven fabric 14, foreign materials may be filtered. For example, the non-woven fabric 14 may be formed to be rippled in a circumference direction of the frame 11 to increase a surface area thereof.

An air cleaner assembly for a vehicle including the circular air filter for a vehicle according to the present invention having the above mentioned composition will hereinafter be described in detail. The air filter 10 may be disposed in the air cleaner assembly installed in an engine compartment of a vehicle. The air cleaner assembly may include an air cleaner body 2 coupled to the air filter 10, an air cleaner cover (not shown) that closes an upper portion of the air cleaner body 2 and the air filter 10 and an air inlet 1 configured to suction exterior air to an interior of the air cleaner body 2. An air duct 4 configured to supply filtered air to an engine may be connected with the air cleaner body 2.

A sitting portion (not shown) with a concave shape may be formed in the air cleaner body 2 and the air filter 10 may be disposed thereon. Further, a side of the sitting portion may be in fluid communication with the air duct 4 and the engaging portion 12 may be configured to be inserted into the side of the sitting portion. In other words, a filter holding portion 2b, coupled to the engaging portion 12, may be formed at the air cleaner body 2. The air cleaner body 2 and the air filter 10 may be coupled to each other as the filter holding portion 2b positions the engaging portion 12. The filter holding portion 2b may be doubly extended from the air cleaner body 2 toward the engaging portion 12. For example, when the filter holding portion 2b is doubly extended and the engaging portion 12 of the air filter 10 is inserted between the double extended portion, the engaging portion 12 may be configured to engage the filter holding portion 2b. For example, a front end of the filter holding portion 2b of an exterior may be configured to be inserted into the insert groove 12a of the engaging portion 12. The contact surface 12b of the engaging portion 12 may abut the filter holding portion 2b of an interior.

When the primary assembly is engaged by the engaging portion 12 to the filter holding portion 2b, the fixing portion 13 of the air filter 10 may be fixed by sliding the filter fixing aperture 2c formed at one side of the air cleaner body 2. For example, the filter fixing aperture 2c may be slidably famed in the air cleaner body 2 when the air filter 10 is engaged to the air cleaner body 2 by the engaging portion 12. In particular, the position of both ends of the air filter 10 may be fixed as the filter fixing aperture 2c slides toward the fixing portion 13 and a front end of the filter fixing aperture 2c may be configured to be inserted into the fixing groove 13a. Penetration apertures may be formed at the filter fixing aperture 2c along a circumference to provide air flow.

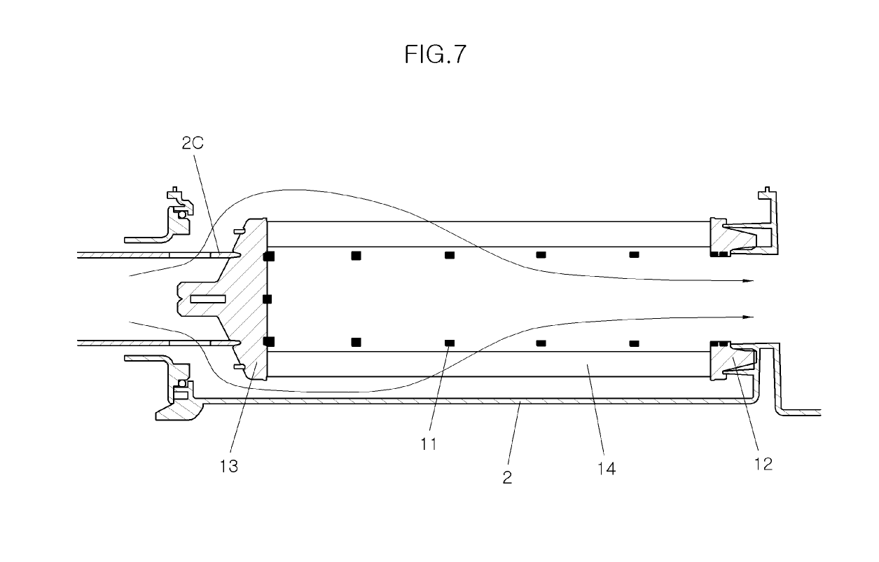

As described above, the instillation of the air filter 10 to an interior of the air cleaner assembly is completed when the air cleaner cover 3 is covered as the air filter 10 engages the air cleaner body 2. As shown in FIG. 7, when an engine is driven in the state that the air filter 10 is installed in the air cleaner assembly, foreign material disposed in the intake air may be removed as air that flows in the air inlet 1 is discharged through the air duct 4 after passing through the non-woven fabric 14 from an exterior to an interior of the air filter 10 by passing through the filter fixing aperture 2c.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims

What is claimed is:

1. A circular air filter for vehicle, comprising:
an air cleaner body having the circular air filter disposed therein and positioned between an air inlet configured to suction air from an exterior and an air duct configured to discharge filtered air to an engine;
a frame formed in a cylinder shape and having a penetration aperture through which air passes along a circumference thereof;
an engaging portion formed at a first end of the frame and coupled to a first side of the air cleaner body; and
a non-woven fabric disposed external to the frame and coupled to the engaging portion for filtering foreign materials.

2. The circular air filter for vehicle of claim 1, wherein the engaging portion is formed in a ring shape, and the engaging portion is configured to be inserted into a filter holding portion that abuts an interior surface and an exterior surface of the engaging portion at a second side of the air cleaner body and supports an end portion of the engaging portion.

3. The circular air filter for vehicle of claim 1, wherein the engaging portion is formed from a rubber material.

4. The circular air filter for vehicle of claim 3, wherein the engaging portion is formed in a ring shape, and the engaging portion is configured to be inserted into a filter holding portion that abuts an interior surface and an exterior surface of the engaging portion at a second side of the air cleaner body and supports an end portion of the engaging portion.

5. The circular air filter for vehicle of claim 1, wherein a fixing portion having a cone shape is formed at opposite second end portion of the engaging portion in the frame, and the fixing portion abuts an end portion of a filter fixing aperture configured to be inserted into to the air cleaner body to maintain a position of the fixing portion.

6. The circular air filter for vehicle of claim 5, wherein the fixing portion is formed from a rubber material.

7. The circular air filter for vehicle of claim 5, wherein fixing grooves are formed as a set depth from a circumference in a circumference direction of the air filter at a surface of the fixing portion, and the fixing portion is configured to move toward the air filter in the air cleaner body to insert a front end of the fixing portion into the fixing groove to fix a position of the air filter.

8. An air cleaner assembly for a vehicle, comprising:
an air filter;
an air cleaner body having the air filter mounted thereto and an air inlet configured to suction air from an exterior coupled to an air duct configured to discharge filtered air to an engine; and
an air cleaner cover configured to open or close an upper surface of the air cleaner body.

9. The air cleaner assembly for a vehicle of claim 8, wherein a filter holding portion doubly extends toward an engaging portion and is coupled to the engaging portion of the air filter at the air cleaner body.

10. The air cleaner assembly for a vehicle of claim 9, wherein a fixing portion having a cone shape is formed at a second end portion of the engaging portion in the frame of the air filter, and a filter fixing aperture, that is inserted into the air cleaner body and is inserted toward the fixing portion and abuts the fixing portion.
